(19) United States
(12) Patent Application Publication
(10) Pub. No.: US 2025/0329130 A1
(43) Pub. Date: Oct. 23, 2025

(54) SYSTEM AND METHOD FOR GENERATING A DATASET ASSOCIATED TO AN OBJECT-OF-INTEREST

(71) Applicant: APPLICATIONS MOBILES OVERVIEW INC., Montreal (CA)

(72) Inventors: Laurent JUPPE, Montreal (CA); Sherif Esmat Omar ABUELWAFA, Montreal (CA); Bryan MARTIN, Montreal (CA); Alvaro DIAZ, Montreal (CA); Antoine AUSSEDAT, Montreal (CA); Yann MAJEWSKI, Montreal (CA); Olha SEREDA, Montreal (CA)

(21) Appl. No.: 19/098,386

(22) Filed: Apr. 2, 2025

(30) Foreign Application Priority Data
Apr. 3, 2024 (EP) 24168341.6

(51) Int. Cl. G06V 10/44; G06F 3/01; G06F 3/16; G06T 1/60; G06T 5/50

(52) U.S. Cl. CPC G06V 10/44; G06F 3/016; G06F 3/16; G06T 1/60; G06T 5/50; G06T 2207/20221

(57) ABSTRACT

Systems and methods for generating a dataset associated with an object-of-interest. The method includes acquiring, by an imaging system, a stream of images of the object-of-interest and analyzing the stream of images by determining whether one or more capture constraint is met. The analysis is performed by continuously executing the following steps. If one or more capture characteristics is met for a portion of the stream of images, the portion of the stream of images is buffered thereby defining the dataset, the dataset being fitted for further processing. If the one or more capture characteristic is not met for the portion of the stream of images, the buffering is precluded until determination is made that the capture characteristic of a subsequent portion of the stream of images is met. The analyzing of the stream of images is stopped in response to a stopping condition is met.

### FIELD

The present technology relates to systems and methods for capturing data, and in particular to systems and methods for the generation of a dataset associated to an object-of-interest.

### BACKGROUND

The advancement of computer systems for three-dimensional (3D) data processing and visualization has seen a significant boost in recent years. However, a guidance of users for utilizing the augmented reality, mixed reality, and virtual reality techniques, interfaces and tools is still missing. Notably, in the context of technologies involving capture of data by the user themselves via corresponding user devices, standard methods for 3D data capture lack features that can guide users into the correct positioning of the user device.

Therefore, there is an interest in developing methods for obtaining information about an object-of-interest while providing precise and relevant information to the user for optimizing a capturing process of the 3D data.

### SUMMARY

Implementations of the present technology have been developed based on developers' appreciation of at least one technical problem associated with the prior art solutions.

In accordance with a first aspect of the present technology, there is provided a computer-implemented method for generating a dataset associated with an object-of-interest. The method includes acquiring, by an imaging system, a stream of images of the object-of-interest, analyzing the stream of images by determining whether one or more capture constraint is met. The analysis is performed by continuously executing, if one or more capture characteristics is met for a portion of the stream of images, buffering the portion of the stream of images, the buffering of the portion of the stream of images defining the dataset, the dataset being fitted for further processing, if the one or more capture characteristic is not met for the portion of the stream of images, precluding the buffering until determination is made that the capture characteristic of a subsequent portion of the stream of images is met and stopping the analyzing of the stream of images in response to a stopping condition being met.

In some non-limiting implementations, for a given capture characteristic, determining whether the given capture characteristic is met includes determining a characteristic value of the given capture characteristic and comparing the characteristic value with a pre-determined criterion, the given capture characteristic being met in response to the pre-determined criterion being fulfilled.

In some non-limiting implementations, a given capture characteristic relates to features of the object-of-interest and/or the imaging system.

In some non-limiting implementations, a given capture characteristic is selected in a group of capture characteristics comprising: a brightness of the object-of-interest and a background thereof, a relative position of the object-of-interest with respect to the imaging system, a color temperature of the object-of-interest and the background thereof, a relative speed of the imaging system with respect to the object-of-interest, a quality of a background of the object-of-interest, and presence of one or more geometric features of the object-of-interest.

In some non-limiting implementations, the one or more capture characteristic comprises a first capture characteristic and a second capture characteristic, and analyzing the stream of images includes determining whether the first capture characteristic is met, the first capture characteristic being selected in a group of priority capture characteristics, in response to the first capture characteristic being met, determining whether the second capture characteristic is met, the second capture characteristic being selected in a group of non-priority capture characteristics and, in response to the first capture characteristic being not met, precluding the buffering of the portion of the stream of images.

In some non-limiting implementations, the method further includes, in response to the first capture characteristic being met, buffering of the portion of the stream of images.

In some non-limiting implementations, determining whether a given capture characteristic is met comprises employing a machine learning algorithm (MLA).

In some non-limiting implementations, the stopping condition is met in response to determining that a number of consecutive images of the stream of images for which the capture characteristic is not met is above a predetermined threshold.

In some non-limiting implementations, the stopping condition is met in response to a number of buffered images reaches a pre-determined threshold, and/or the one or more capture characteristics of the buffered portion of the stream of images meets a pre-determined criterion.

In some non-limiting implementations, the method further includes executing a post-processing analysis of the buffered portion of the stream of images, the post-analysis comprising discarding, in response to a number of images of the buffered portion of the stream of images for which the capture characteristic is not met is above a predetermined threshold, the buffered portion of the stream of images.

In some non-limiting implementations, the method further includes, in response to a number of images of the buffered portion of the stream of images for which the capture characteristic is not met is above a predetermined threshold, causing the acquisition and analysis of another stream of images.

In some non-limiting implementations, the method further includes, upon buffering a first portion of the stream of images and determining that the capture characteristic is not met for a given image consecutive to the first portion in the stream of images, buffering a pre-determined number of images consecutive to the first portion of the stream of images including the given image.

In some non-limiting implementations, the method further includes providing, to a user of the imaging system, an indicator indicative of a current value of the capture characteristic in a near-to-real time manner on a user device.

In some non-limiting implementations, providing the indicator includes overlaying the indicator on a representation of the object-of-interest on the user device, causing the user device to vibrate, vibrations being modulated based on a number of buffered images and/or causing the user device to emit sound effects, the sound effects being modulated based on a number of buffered images.

In some non-limiting implementations, buffering the portion of the stream of images comprises storing the portion of the stream of images on a memory communicably connected to the imaging system.

In some non-limiting implementations, the memory is hosted in an electronic device embedding the imaging system.

In some non-limiting implementations, the method further includes transmitting the dataset fitted for further processing to a server communicably connected to the memory.

In some non-limiting implementations, the memory is a server remotely connected to the imaging system.

In some non-limiting implementations, the dataset is formed by raw images of the buffered portion of the stream of images.

In some non-limiting implementations, the portion of the stream of images is a single image of the stream of images.

In some non-limiting implementations, the method further includes determining target features of the object-of-interest based on the dataset fitted for further processing.

In some non-limiting implementations, the stream of images is a live stream of images.

In some non-limiting implementations, the method further includes providing instructions to a user of the imaging system, execution of the instructions causing the one or more capture characteristic to be met.

In some non-limiting implementations, the object-of-interest is a portion of a human body.

In a second aspect of the present technology, there is provided a system for generating a dataset associated with an object-of-interest, the system comprising a controller and a memory storing a plurality of executable instructions which, when executed by the controller, cause the system to perform the method.

In a third aspect of the present technology, there is provided a non-transitory computer-readable medium comprising computer-readable instructions that, upon being executed by a system, cause the system to perform the method.

### BRIEF DESCRIPTION OF THE DRAWINGS

These and other features, aspects and advantages of the present technology will be better understood with regard to the following description, appended claims and accompanying drawings where:

FIG. 1 illustrates a capture of geometric data of an object-of-interest by an electronic device in accordance with some implementations of the present technology;

FIG. 2 depicts a representative computing environment of the electronic device of FIG. 1 for executing computer-implemented described in the present disclosure, in accordance with some implementations of the present technology;

FIG. 3 illustrates front and rear views of the electronic device of FIG. 1 in accordance with some implementations of the present technology;

FIG. 4 is a flow diagram of a pipeline for generating a dataset associated to an object-of-interest in accordance with some implementations of the present technology;

FIG. 5 is a representation of a stream of images analyzed for the generation of a dataset associated to an object-of-interest in accordance with some implementations of the present technology;

FIG. 6A is a representation of a stream of images analyzed for the generation of a dataset associated to an object-of-interest in accordance with some other implementations of the present technology;

FIG. 6B is a representation of the stream of images analyzed for the generation of a dataset associated to the object-of-interest in accordance with yet some other implementations of the present technology;

FIG. 7 illustrates a rendering by a display of the electronic device of FIG. 1 upon capturing geometric data of the object-of-interest in accordance with some implementations of the present technology;

FIGS. 8A to 8E illustrate position indicators indicative of relative positions of the electronic device of FIG. 1 and the object-of-interest in accordance with some implementations of the present technology;

FIGS. 9A to 9C illustrate background quality indicators associated to an environment of the object-of-interest in accordance with some implementations of the present technology;

FIG. 10 illustrates a light condition indicator associated to the environment of the object-of-interest in accordance with some implementations of the present technology;

FIG. 11A is an image of a human hand with hand joints marked thereon;

FIG. 11B is an image of a human body with body joints marked thereon;

FIG. 12 is an image of a human body with indication of a rotation of an imaging system represented thereon;

FIG. 13 is a flow chart illustrating operations of a method for the acquisition of data associated to an object-of-interest in accordance with some implementations of the present technology;

FIG. 14 is an experimental measurement of a relative speed of a capturing device relatively to an object-of-interest for each image of a stream of images.

### DETAILED DESCRIPTION

Various implementations of the described technology will be described more fully hereinafter with reference to the accompanying drawings. The present technology may, however, be embodied in many different forms and should not be construed as limited to the implementations set forth herein. Rather, these implementations are provided so that the disclosure will be thorough and complete, and will fully convey the scope of the disclosed technology to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular implementations and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any step diagrams, flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional step labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some implementations of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

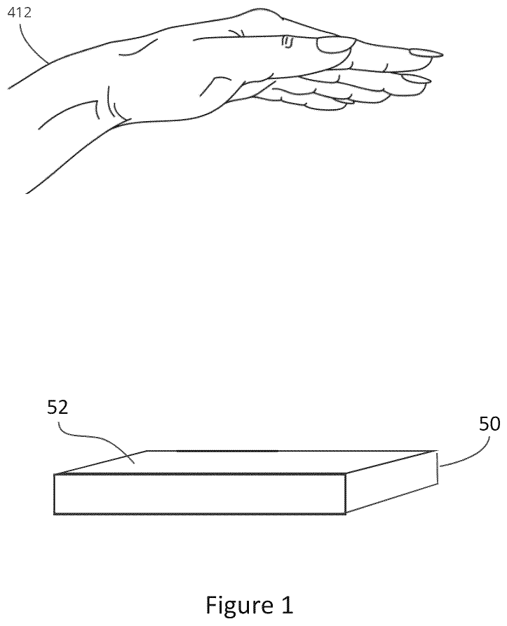

FIG. 1 illustrates a capture of images of an object-of-interest 412 by an electronic device 50 in accordance with some implementations of the present technology. In this illustrative example, the object-of-interest 412 is a human hand. As will be described in greater details herein after, the electronic device 50 is configured to generate a dataset about the object-of-interest 412 including information about the object-of-interest relatively to the electronic device 50. The dataset may include information such as geometrical features, relative distance and positions relatively to the electronic device 50, etc. In this implementation, a front side 52 of the electronic device 50 is oriented towards the object-of-interest 412. The front surface 116 may for example include sensors and imaging system to capture images of the object-of-interest 412.

The electronic device 50 may be associated with a user. As such, the electronic device 50 can sometimes be referred to as a “client device”, “user device” or “client electronic device”. It should be noted that the fact that the electronic device 50 is associated with a user does not need to suggest or imply any mode of operation-such as a need to log in, a need to be registered, or the like.

In one aspect, the present technology provides a user of the electronic device with guidance about how to perform said data collection. It can be said that the guidance aims at optimizing the capturing process such that an accuracy of the obtained geometric data is increased.

The present technology also aims at minimizing an amount of buffered data used to determine geometric features of the object-of-interest. As will be described in greater detail, a stream of images of the object-of-interest is analyzed, and a portion of the stream is buffered in a memory for further processing in response to a capture characteristic being met for said portion. In the context of the present disclosure, a capture characteristic refers to a parameter that can be measured for each portion of the stream of images, for example for each image of the stream of images. A given capture characteristic is met in response to a characteristic value of the corresponding parameter is within a target range of value and/or has a target value. For example, an illustrative parameter may be the relative distance between the electronic device 50 and the object-of-interest 412. In this example, the corresponding capture characteristic may be met in response to the relative distance (i.e. the characteristic value) is between 30 and 70 cm. The capture characteristics are described in greater detail hereinafter.

It should be noted that, although the electronic device 50 is depicted as being fixed and the object-of-interest 412 as being mobile, it should not limit the scope of the present technology. In the context of the present disclosure, a relative position of the electronic device 50 to the object-of-interest varies. For example, the object-of-interest 412 may be fixed and the electronic device 50 may move around the object-of-interest 412.

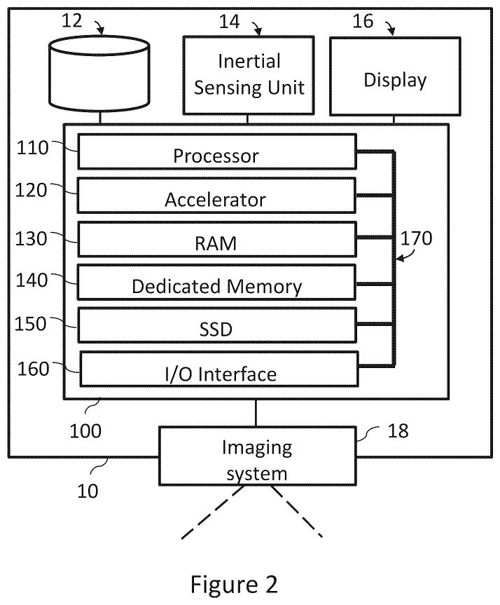

FIG. 2 is a schematic representation of an electronic device 10 in accordance with non-limiting implementations of the present technology. The electronic device 50 may be implemented as the electronic device 10. In some implementations, the device 10 includes a computing unit 100 configured to receive captured images or data related to an object-of-interest. The computing unit 100 is described in greater detail hereinbelow.

The device 10 includes an imaging system 18 that is configured to capture Red-Green-Blue (RGB) images and may include depth sensors to acquire RGB-Depth (RGBD) images. The imaging system 18 may include image sensors such as, but not limited to, Charge-Coupled Device (CCD) or Complementary Metal Oxide Semiconductor (CMOS) sensors and/or digital cameras. Broadly speaking, any device suitable for capturing RGBD images may be used as the imaging system 18 including but not limited to depth sensors, 3D scanners or any other suitable devices. Imaging system 18 may convert an optical image into an electronic or digital image and may send captured images to the computing unit 100. The imaging system 18 may provide the device 10 with a continuous flux, or “stream”, of captured images. Thus, the captured images defined a continuous stream with a typical rate of 30 to 60 frames per second.

The device 10 may include an Inertial Sensing Unit (ISU) 14 configured to be used in part by the computing unit 100 to determine a pose of the imaging system 18 and/or the device 10. Therefore, the computing unit 100 may determine a set of coordinates describing the location of the imaging system 18, and thereby the location of the device 10, in a coordinate system based on the output of the ISU 14. Generation of the coordinate system is described hereinafter. The ISU 14 may comprise 3-axis accelerometer(s), 3-axis gyroscope(s), and/or magnetometer(s) and may provide velocity, orientation, and/or other position related information to the computing unit 100.

Further, the device 10 may include a screen or display 16 capable of rendering color images, including 3D images. In some embodiments, the display 16 may be used to display live images captured by the imaging system 18, Augmented Reality (AR) images, Graphical User Interfaces (GUIs), program output, etc. In some embodiments, display 16 may comprise and/or be housed with a touchscreen to permit users to input data via some combination of virtual keyboards, icons, menus, or other Graphical User Interfaces (GUIs). In some implementations, display 16 may be implemented using a Liquid Crystal Display (LCD) display or a Light Emitting Diode (LED) display, such as an Organic LED (OLED) display. In other embodiments, display 16 may remotely communicably connected to the device 10 via a wired or a wireless connection (not shown), so that outputs of the computing unit 100 may be displayed at a location different from the location of the device 10. In this situation, the display 16 which may be operationally coupled to, but housed separately from, other functional units and systems in device 10. The device 10 may be, for example, an iPhone® from Apple or a Galaxy® from Samsung, or any other mobile device whose features are similar or equivalent to the aforementioned features. The device may be, for example and without being limitative, a handheld computer, a personal digital assistant, a cellular phone, a network device, a camera, a smart phone, an enhanced general packet radio service (EGPRS) mobile phone, a network base station, a media player, a navigation device, an e-mail device, a game console, or a combination of two or more of these data processing devices or other data processing devices.

The device 10 may comprise a memory 12 communicably connected to the computing unit 100 and configured to store data, captured images, depth values, sets of coordinates of the device 10, set of coordinates of the object-of-interest, raw data provided by ISU 14 and/or the imaging system 18. The memory 12 may be embedded in the device as in the illustrated embodiment of FIG. 2 or located in an external physical location. The computing unit 100 may be configured to access a content of the memory 12 via a network (not shown) such as a Local Area Network (LAN) and/or a wireless connection such as a Wireless Local Area Network (WLAN).

The device 10 may also include a power system (not depicted) for powering the various components. The power system may include a power management system, one or more power sources (e.g., battery, alternating current (AC)), a recharging system, a power failure detection circuit, a power converter or inverter and any other components associated with the generation, management and distribution of power in mobile or non-mobile devices.

In some embodiments, the computing unit 100 may be implemented by any of a conventional personal computer, a controller, and/or an electronic device (e.g., a server, a controller unit, a control device, a monitoring device etc.) and/or any combination thereof appropriate to the relevant task at hand. In some embodiments, the computing unit 100 comprises various hardware components. The computing unit 100 may be a computer specifically designed to operate a machine learning algorithm (MLA) and/or deep learning algorithms (DLA). The computing unit 100 may be a generic computer system.

In some other embodiments, the computing unit 100 may be an “off the shelf” generic computer system. In some embodiments, the computing unit 100 may also be distributed amongst multiple systems. The computing unit 100 may also be specifically dedicated to the implementation of the present technology. As a person in the art of the present technology may appreciate, multiple variations as to how the computing unit 100 is implemented may be envisioned without departing from the scope of the present technology.

Communication between the various components of the computing unit 100 may be enabled by one or more internal and/or external buses 170 (e.g. a PCI bus, universal serial bus, IEEE 1394 “Firewire” bus, SCSI bus, Serial-ATA bus, ARINC bus, etc.), to which the various hardware components are electronically coupled.

The input/output interface 160 may provide networking capabilities such as wired or wireless access. As an example, the input/output interface 160 may comprise a networking interface such as, but not limited to, one or more network ports, one or more network sockets, one or more network interface controllers and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the RAM 130 and executed by the processor 110. Although illustrated as a solid-state drive 150, any type of memory may be used in place of the solid-state drive 150, such as a hard disk, optical disk, and/or removable storage media.

The processor 110 may be a general-purpose processor, such as a central processing unit (CPU) or a processor dedicated to a specific purpose, such as a digital signal processor (DSP). In some embodiments, the processor 110 may also rely on an accelerator 120 dedicated to certain given tasks, such as executing the methods set forth in the paragraphs below. In some embodiments, the processor 110 or the accelerator 120 may be implemented as one or more field programmable gate arrays (FPGAs). Moreover, explicit use of the term “processor”, should not be construed to refer exclusively to hardware capable of executing software, and may implicitly include, without limitation, application specific integrated circuit (ASIC), read-only memory (ROM) for storing software, RAM, and non-volatile storage. Other hardware, conventional and/or custom, may also be included.

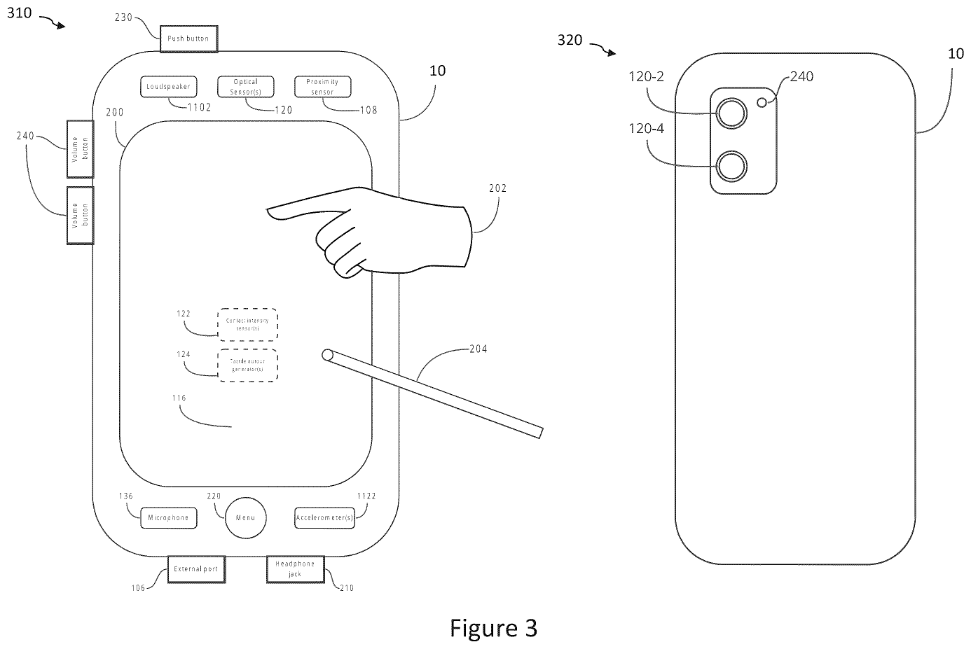

With respect to FIG. 3, representation 310 shows an illustrative example of a front side 312 of the electronic device 10. The front side 52 of the electronic device 50 may be implemented as the front side 312.

In some embodiments, the electronic device 10 may include the touch-sensitive display 200, headphone jack 210, menu button 220, push button 230 for powering the device on/off and locking the electronic device 10, volume adjustment button(s) 240, and docking/charging external port 106. Push button 230 may also be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, the electronic device 10 may accept verbal input for activation or deactivation of some functions through microphone 136. The electronic device 10 may also include the at least one contact intensity sensor 122 for detecting intensities of contacts on touch-sensitive display system 116 and/or the at least one tactile output generator 124 for generating tactile outputs for a user of the electronic device 10.

The front side 312 of the electronic device 10 may also include a touch screen 116, that can be the display 16. The touch screen 116 may display the at least one graphic within user interface (UI) 200. In these implementations, a user may select the at least one graphic by making a gesture on the graphics, for example, with one or more fingers 202 (not drawn to scale in the figure) or one or more styli 204 (not drawn to scale in the figure). In some implementations, selection of one or more graphics occurs when the user breaks contact with the at least one graphic. In some implementations, the gesture may include the at least one tap, the at least one swipe (from left to right, right to left, upward and/or downward) and/or a rolling of a finger (from right to left, left to right, upward and/or downward) that has made contact with the electronic device 10.

In some embodiments, the electronic device 10 may also include the at least one physical buttons, such as menu button 220. Menu button 220 may be used to navigate to any application 1060 in a set of applications that are, optionally executed on the electronic device 10. Alternatively, in some embodiments, the menu button is implemented as a soft key in a GUI displayed on the touch-sensitive display 200.

Representation 320 of FIG. 3 depicts a back side 322 of the electronic device 10 in accordance with non-limiting implementations of the present technology. The back side 322 includes optical sensors 120-2 and 120-4. In some implementations, the back side 322 may include at least one depth sensor 240 (such as a time-of-flight (“ToF”) sensor, a structured-light sensor or any other suitable sensor. The optical sensors 120, 120-2 and 120-4 are part of the imaging system 18 of the electronic device 10.

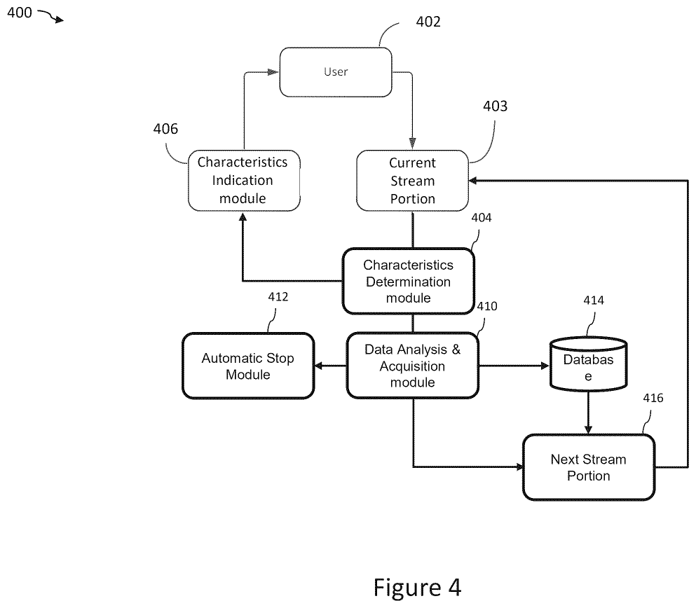

FIG. 4 depicts a high-level flow diagram of a data capture pipeline 400 in accordance with implementations of the present technology. It is to be expressly understood that the data capture pipeline 400 as depicted are merely an illustrative implementation of the present technology. In some cases, what are believed to be helpful examples of modifications to the pipeline 400 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case.

It will be understood that the pipeline 400 or the at least one steps thereof may be performed by a computer system, such the electronic device 10. The pipeline 400, or at least one step thereof, may be embodied in computer-executable instructions that are stored in a computer-readable medium, such as a non-transitory mass storage device, loaded into memory and executed by a CPU. Some steps or portions of steps in the flow diagram may be omitted or changed in order.

In use and as will be described in greater detail herein after, the computer system 100 may capture a stream of images of the object-of-interest where the object-of-interest is in a field of view of the imaging system 18. The computer system 100 may generate data to indicate and guide a user of the electronic device 10 in order to capture images that can be used for further processing to determine, for example, geometric features of the object-of-interest.

To do so, the computer system 100 access a stream of images of the object-of-interest. The stream may have been captured by the imaging system 18. In some implementations, the computer system 100 may analyze the stream of images in a near-to-real time manner upon the imaging system 18 being captured. Broadly speaking, the computer system 100 may determine, for each portion of the stream of images, whether a capture characteristic is met. In response to the capture characteristic is met, the portion of the stream of images is buffered in a memory, thereby forming a dataset for further processing. Therefore, portions of the stream of images that are not deemed relevant and/or optimal for further processing are not buffered, which optimizes storage of data by the computer system 100. Only portions that are deemed relevant and/or optimal for further processing are buffered. Digital memory usage is thus optimized.

As will also be described hereinafter, the electronic device 10 also provides indication to the user to indicate, via the user interface 200 for example, adjustments that the user may perform to cause the capture characteristic to be met.

Referring to FIG. 4, the pipeline 400 includes accessing a current portion of the stream of images at block 403 and executing a characteristic determination module by the electronic device at block 404 on the current stream portion. It should be noted that the denomination “current” stream portion is to indicate that the given stream portion is currently being processed through the pipeline 400. Execution of the characteristic determination module causes the computer system 100 to determine if a capture characteristic is met for a portion (e.g. a given image) of the stream of images. It should be noted that in some implementations, the computer system 100 determines whether a plurality of capture characteristics are met simultaneously, or “in parallel”.

A capture characteristic may relate to features of the object-of-interest 412 and/or the imaging system 18. A capture characteristic may be determined by the computer system 100 based on metadata extracted from images of the stream of images. Said metadata may be processed in parallel to the analysis of the stream of images. For example, the computer system 100 may employ a machine-learning algorithm (MLA) to determine the characteristic values of the capture characteristics. The MLA may have been trained to take images of an object-of-interest as an input and output a characteristic value of a capture characteristic. The computer system 100 may also use parameters of the imaging system 18 and/or the electronic device 50, such as the inertial sensing unit 14, to determine whether a capture characteristic is met.

A capture characteristic may be selected in a first group of capture characteristics including, for example and without limitations: a relative distance between the object-of-interest and the image sensing device, an orientation of the image sensing device, an acceleration of the image sensing device relatively to the object-of-interest, a speed of the image sensing device relatively to the object-of-interest, a motion of the imaging system relatively to the object-of-interest, a brightness of the images of the stream of images, a color temperature of the images of the stream of images, a color histogram of the images of the stream of images, specific features extracted from character recognition (OCR, QR-Codes, etc.), a time and date of a capture of the images of the stream of images, a geographic location of the imaging system, a relative distance between the imaging system and feature points determined on the object-of-interest, a state of a Bluetooth module of the electronic device 50 and a state of a NFC/RFID chip of the electronic device 50. It can be said that the first group of capture characteristic is related to parameters of the imaging device 18 and/or the electronic device 50 (e.g. parameters taken independently from one another or in an interdependent manner).

For example, in some implementations, the capture characteristic related to the speed of the imaging system is met in response to the relative speed is below 0.1 m/s and is not met otherwise. As another example, the capture characteristic related to the speed of the state of the Bluetooth module of the electronic device 50 is met in response to Bluetooth communication is enabled on the electronic device 50 and is not met otherwise. The determination of characteristics of the first group of capture characteristics may be executed in parallel to receiving the stream of images or once all of the images of the stream have been received.

The capture characteristic may also be selected in a second group of capture characteristics including, for example and without limitations: a prediction score indicative of a probability of a presence of two-dimensional (2D) features of the object-of-interest and a prediction score indicative of a probability of a presence of three-dimensional (3D) features of the object-of-interest. In these examples, the prediction score are determined by dedicated machine learning algorithms (MLAs) based on images of the stream of images during the analysis thereof. The determination may be executed in parallel to receiving the stream of images or once all of the images of the stream have been received. The 3D features may be, in the illustrative circumstance where the object-of-interest 412 is a human body or a portion thereof, hand joints, face feature points, full body joints, etc. It can be said that the second group of capture characteristic is related to ML-based features of the object-of-interest.

For example, in some implementations, the capture characteristic related to the prediction score indicative of a probability of a presence of 2D or 3D features of the object-of-interest is met in response to the prediction score being above a given threshold and is not met otherwise. As another example, the capture characteristic related to prediction score indicative of a probability of a presence of 3D features of the object-of-interest is met in response to a number of detected joints is above a given threshold and is not met otherwise.

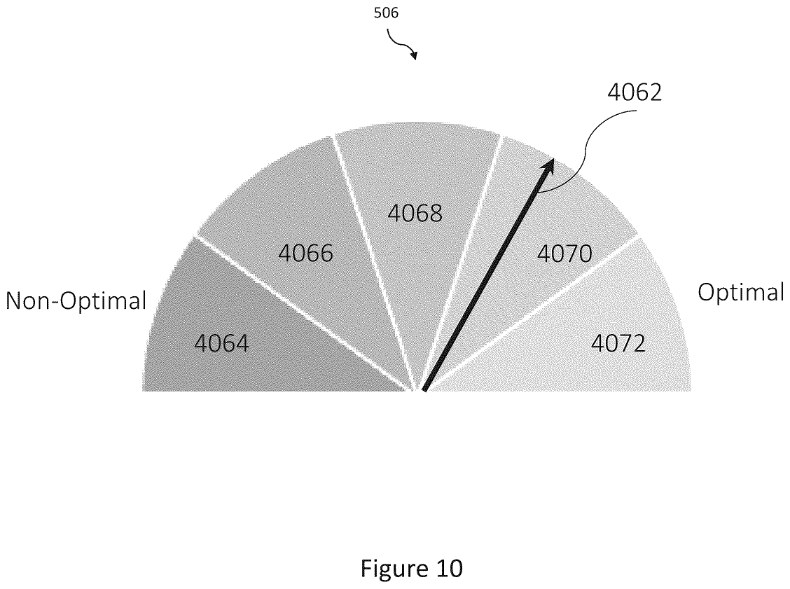

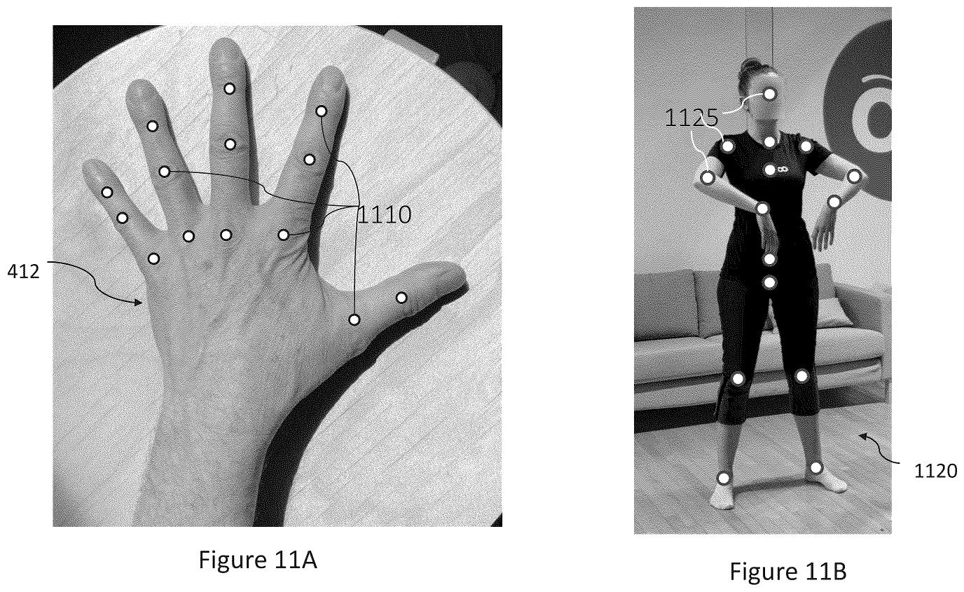

FIG. 11A is an image of the human hand 412 with hand joints 1110 marked thereon. As previously described, a given example of a capture characteristic is related to a probability of a presence of detected joints of the object-of-interest. For example, during analysis of the stream of images, the electronic device 100 may determine a number of detected joints on a given image. If the probability that a number of joints is above a given threshold, then the capture characteristic is met and the given image may be buffered.

In the example of FIG. 11A, fourteen joints are detected with a probability of 98%. The threshold may be 90%. Therefore, the capture characteristic related to probability of a presence of detected joints of the object-of-interest 412 would be met and the image of FIG. 11A would be buffered. In some implementations, the threshold is related to the number of joints itself. For example, the threshold may be 50% and the capture characteristic related to the presence of detected joints of the object-of-interest 412 would be met and the given image may be buffered if the number of detected joints is seven (7).

The same may be applied to other object-of-interest such as a human body 1120 shown on FIG. 11B. FIG. 11B is an image of the human body 1120 with body joints 1125 marked thereon. In this example, during analysis of the stream of images, the electronic device 100 may determine a number of detected body joints on a given image. If the probability that a number of joints is above a given threshold, then the capture characteristic is met and the given image may be buffered.

The capture characteristic may also be selected in a third group of capture characteristics including, for example and without limitations: a shape of the object-of-interest or a portion thereof, a 3D comparison with a 3D reference model, a set of local descriptors of the object-of-interest such as 3D Shape Context, Point Feature Histogram, Fast Point Feature Histogram, Radius-Based Surface Descriptor, Signatures of Histograms of Orientations, Spin image, Unique Shape Context or 3D curvature distribution, a data point density of a 3D point cloud generated based on the stream of images, a number of 3D vertices, etc. A determination of these parameters may be executed in parallel to receiving the stream of images or once all of the images of the stream have been received. It can be said that the third group of capture characteristic is related to geometric-based parameters of the object-of-interest.

For example, in the context of human body characterization, a capture characteristic of the third group of capture characteristics may be assessed by executing a 3D comparison of a head of said human body with a sphere, executing a 3D comparison of arms and/or legs of said human body with cylinders, executing a 3D comparison of a ground surface with a plane, etc.

For example, in some implementations, the capture characteristic related to the shape of the object-of-interest of a portion thereof is met in response to a number of detected primitives is above a given threshold and is not met otherwise. As another example, the capture characteristic related to the 3D comparison with a 3D reference model is met in response to a 3D distance between a 3D reconstruction of the object-of-interest, based on the stream of images, and a 3D model, that may have been selected by the user of the electronic device 50, is below a given threshold and is not met otherwise.

The capture characteristic may also be selected in a fourth group of capture characteristics including, for example and without limitations: a 3D feature points accumulation, 3D specific anchor points, a Scale Invariant Feature Transform (SIFT) feature points detection and matching, etc. A determination of these parameters may be executed in parallel to receiving the stream of images or once all of the images of the stream have been received. It can be said that the fourth group of capture characteristic is related to feature-based parameters of the object-of-interest.

For example, in some implementations, the capture characteristic related to the 3D feature points accumulation is met in response to an average number of 3D data points of the object-of-interest determined based on each image of the stream of image is above a given threshold, and is not met otherwise. As another example, the capture characteristic related to the SIFT feature points detection and matching is met in response to a number and/or a quality assessment of detected SIFT feature points is above a given threshold and is not met otherwise.

It should be noted that the division of the examples of capture characteristics into four groups is not limitative and should not limit the scope of the present technology. The division is merely done to ease a reading of the present disclosure. Other capture characteristics may be implemented in alternative implementations, such as a number of images in the stream of images or a number of buffered images, this aspect is not limitative.

Referring back to FIG. 4, the electronic device 50 determines whether or not the capture characteristic is met at block 404. It should be noted that the electronic 100 may determine whether a plurality of capture characteristics are met concurrently.

In parallel, the electronic device 50 generates visual indicators of the capture characteristic at block 406. The visual indicators are displayed to the user, for example on the display 16, at block 402. Example of the visual indicators are illustrated herein after. As the images captured by the imaging system 18 may be a live stream of images, the visual indicators are indicative of the capture characteristics in a near-to-real time manner. In circumstances where a capture characteristic is not met (i.e. outside of its respective range of target value), the user may adjust a scene (e.g. adjusting a brightness of the object-of-interest, adjusting a distance between the imaging system 18 and the object-of-interest, etc.) based on the indications of the visual indicators.

In response to the capture characteristic being determined as being met at block 408, the electronic device 10 executes a Data Analysis & Acquisition (DAA) module at block 410. It should be noted that, in some implementations, the electronic device 10 executes the DAA module at block 410 in response to a plurality of capture characteristics being met concurrently (i.e. in a simultaneous manner).

Execution of the DAA module may cause the electronic device 50 to start buffering images of the stream of images in a database 414. Said database may be for example and without limitation the database 12 (see FIG. 2) or a remote server in communication with the electronic device 50. It can thus be said that the buffering of the images automatically starts once the capture characteristic is met. Therefore, images that are identified as not suitable for further processing are not stored in the database 414. In other words, the images for which the capture characteristic is not met are note buffered, which reduces the amount of non-useful data and thus increase an efficiency of digital memory usage.

In response to determination by the computer system 100 that a stopping condition is met, the electronic device 50 executes an automatic stop module 412 to stop the buffering of images in the database 414. Otherwise, the buffering continues while the capture characteristic is met. It should be noted that the buffering may be precluded or “paused” in response to the capture characteristic is no longer met, and resumed once determination is made that the capture characteristic is met. More specifically, the buffering is precluded by accessing a subsequent portion of the stream of image at operation 416 (e.g. a subsequent image of the stream of images) without buffering the current portion of the stream of image.

For example, the stopping condition may be met in response to a number of buffered images reaches a pre-determined threshold. Additionally or alternatively, the stopping condition may be met in response to the one or more capture characteristics of the buffered portion of the stream of images meeting a pre-determined criterion. For example, a capture characteristic may relate to points of view of the imaging system around the object-of-interest. More specifically, the capture characteristic may be met in response to the imaging system having performed a full rotation (360°) around the object-of-interest. The portion of the full rotation that has been performed may be measured, in this example, based on data provided by the inertial sensing unit 14 during the capture of the stream of images.

Therefore, the DAA module executed at operation 410 may either cause the execution of the automatic stop module at operation 412 in response to a stopping condition being met, buffering the current portion of the stream of images at operation 414, or precluding the buffering and access a subsequent portion of the stream of image at operation 416 and use said portion as a current portion at block 403 until the stream of images is fully processed.

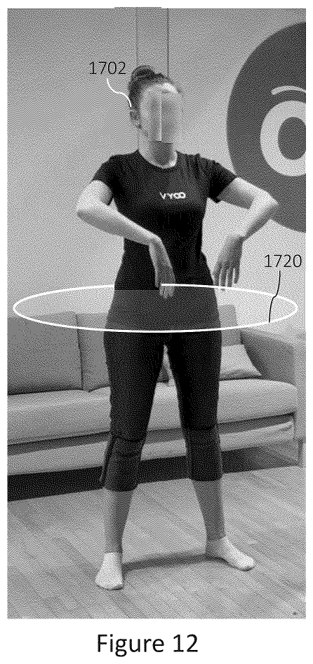

FIG. 12 shows a human body 1702, that is the object-of-interest in this example, for which a rotation 1720 of the imaging system 18 has to be performed for the aforementioned capture characteristic to be met. Once the rotation 1720 has been performed according to data provided by the inertial sensing unit 16, the stopping condition is met and the electronic device may stop analyzing the stream of images. Other stopping conditions may be implemented in alternative implementations, this aspect is not limitative.

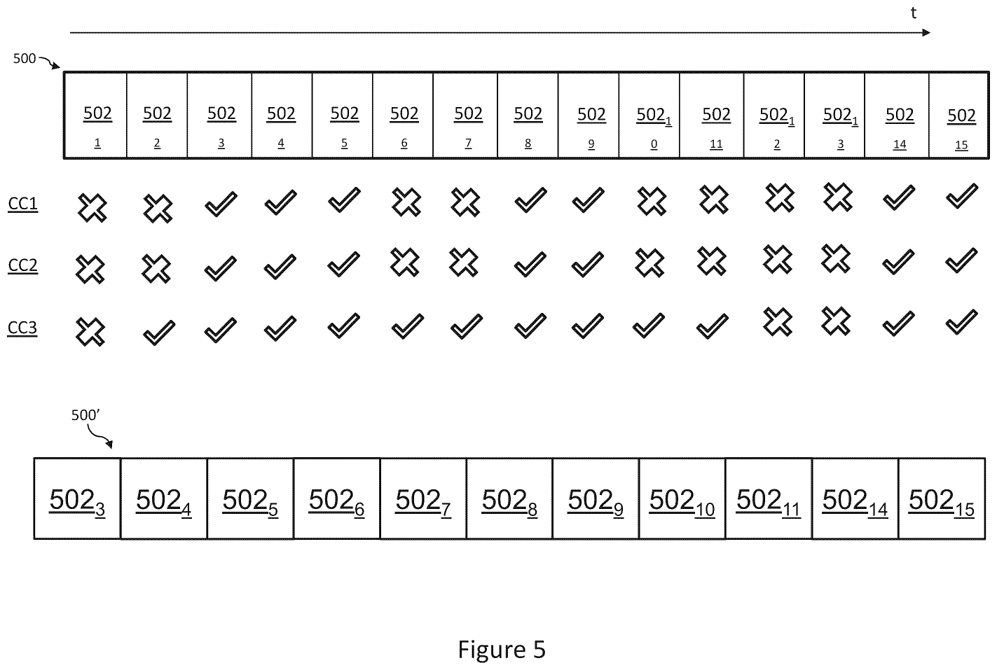

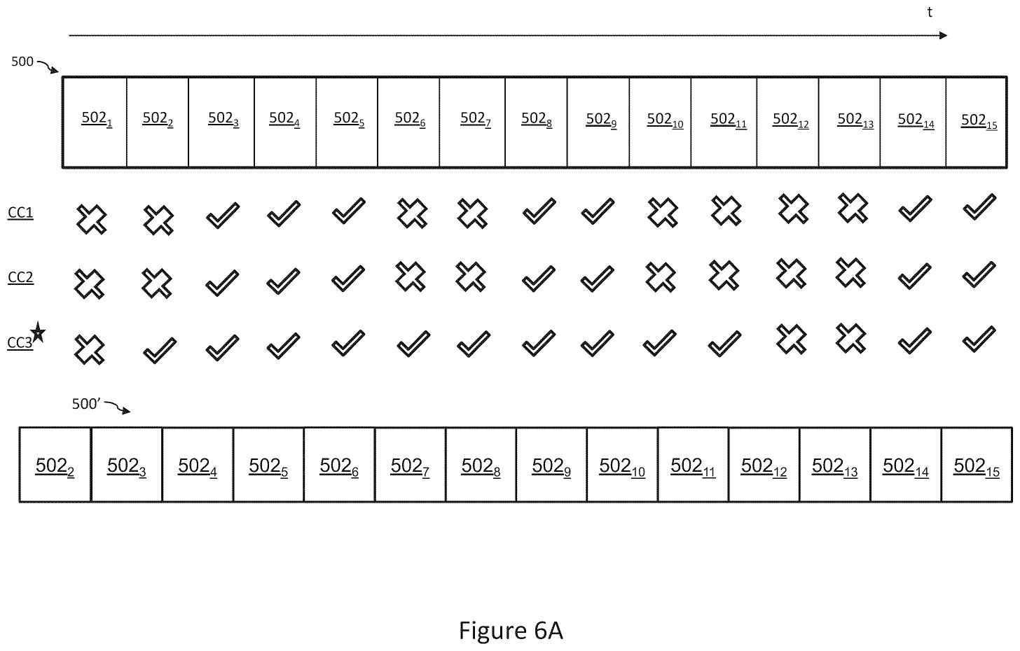

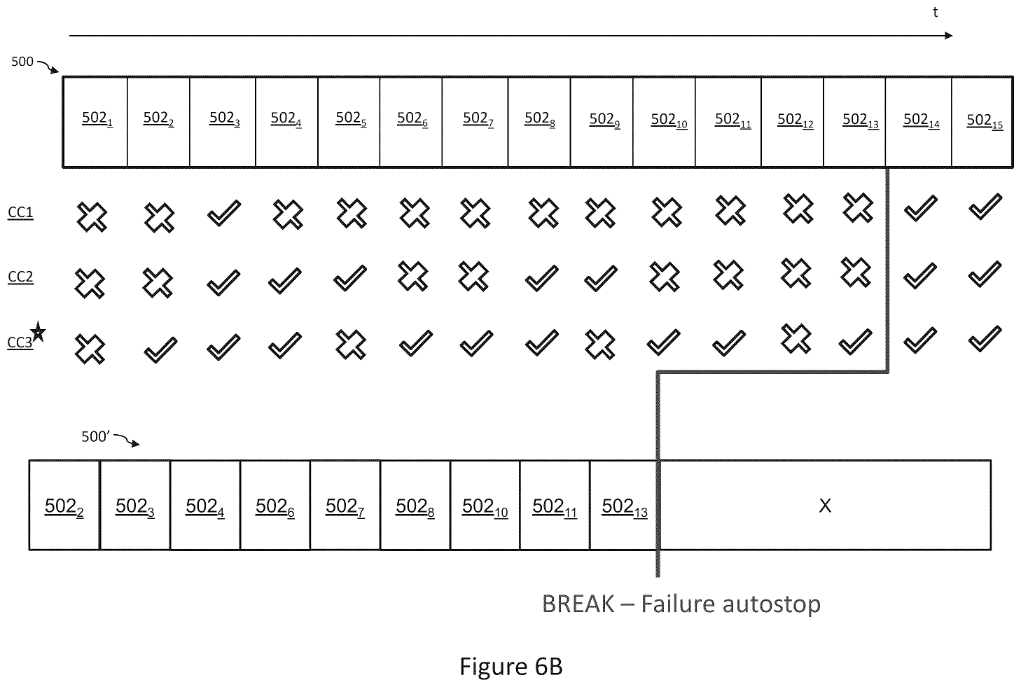

FIGS. 5, 6A and 6B illustrate examples of executions of the pipeline 400 on a stream of images 500 according to some non-limiting implementations of the present technology.

With reference to FIG. 5, there is depicted a stream of image 500 including consecutive images 5021 to 50215. In this example, the electronic device 50 is configured to analyze the stream 500 according to three capture characteristics noted CC1, CC2 and CC3. There may be a different number of capture characteristics in alternative examples. It can be said that, in this example, the electronic device 50 assesses three given capture characteristics.

In this illustrative example, the electronic device 50 determines that none of the capture characteristics CC1, CC2 and CC3 are met on the image 5021. The electronic device 50 further determines that the capture characteristics CC1 and CC2 are not met while the capture characteristic CC3 is met on the image 5022. In this implementation, the electronic device 50 is configured to cause the buffering of a given image of the stream of image 500 in response to all of the assessed capture characteristics being met and does not buffer the image otherwise. Therefore, in this example, the images 5021 and 5022 are not buffered.

The electronic device 50 further determines that all of the capture characteristics CC1, CC2 and CC3 are met on the images 5023 to 5025. Therefore, the images 5023 to 5025 are buffered and form a buffered sequence 500′ of images. The buffered sequence 500′ may also be referred to a dataset fitted for further processing.

In this illustrative implementation, upon buffering a first portion of the stream of images and determining that the capture characteristic is not met for a given image consecutive to the first portion in the stream of images, the electronic device 100 causes a buffering of a pre-determined number of images consecutive to the first portion of the stream of images including the given image. In the example of FIG. 5, the pre-determined number is two. The electronic device 50 thus further determines that the capture characteristics CC1 and CC2 are not met while the capture characteristic CC3 is met on the images 5026 and 5027. Given that the images 5023 to 5025 have been buffered, the images 5026 and 5027 are also buffered. They are thus added to the buffered sequence 500′ of images.

In alternative implementations, the images 5026 and 5027 would not have been buffered given that all the capture characteristics are not met for each of these images.

In the illustrative example of FIG. 5, the electronic device 50 further determines that all the capture characteristics CC1, CC2 and CC3 are met on the images 5028 and 5029. Therefore, the images 5028 and 5029 are buffered and thus added to the buffered sequence 500′.

The electronic device 50 further determines that at least one of the capture characteristics CC1, CC2 and CC3 is not met on the images 50210 to 50213. The images 50210 and 50211 are buffered and thus added to the buffered sequence 500′ for the same reason that the images 5026 and 5027 have been buffered. However, in this example, the pre-determined number of images where at least one capture characteristic is not met and being still buffered after the buffering of image where all the capture characteristics are met is two. Therefore, the images 50212 and 50213 are not buffered.

The electronic device 50 further determines that all the capture characteristics CC1, CC2 and CC3 are met on the images 50214 and 50215. Therefore, the images 50214 and 50215 are buffered and thus added to the buffered sequence 500′.

The dataset may then be processed to determined geometric features of the object-of-interest, identifying feature points on the object-of-interest, to generate a 3D point cloud, to perform 3D measurement on the generated 3D point cloud, to perform object recognition using Machine Learning algorithms (MLA), to perform MLA augmentation operations, to perform 3D model fitting on the object-of-interest and/or any other suitable operations.

In some implementations, the electronic device 500 further executes a post-processing analysis of the buffered portion of the stream of images. To do so, the electronic device 50 determines a ratio between a number of buffered images for which the capture characteristic is not met, and a number of buffered images for which the capture characteristic is met. If the ratio is above a given ratio threshold (e.g. 0,15), the electronic device 50 may cause the discarding of the stream of images. Indeed, if the capture characteristic is not met for one image every five images of the buffered sequence 500′, the buffered sequence 500′ may be discarded due to poor quality of thereof. In response, the electronic device 50 may cause acquisition of another stream of image (e.g. by prompting instructions to the user to do so on the display 16).

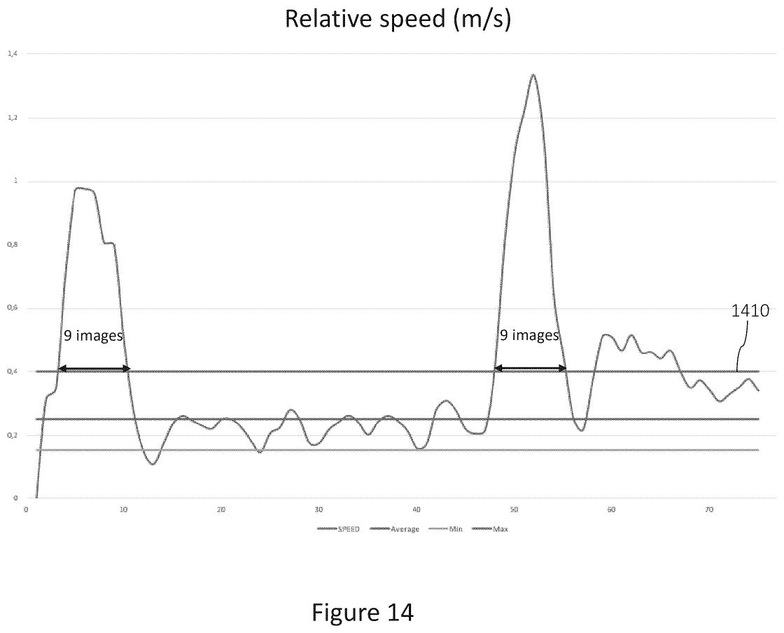

For example, FIG. 14 is an experimental measurement of a relative speed of a capturing device relatively to an object-of-interest for each image of a stream of images. In this example, the relative speed is above a maximum speed threshold 1410 for nine (9) consecutive images between image no. 4 and image no. 12. The relative speed is also above the maximum speed threshold 1410 for nine (9) consecutive images between image no. 48 and image no. 56 of the stream of images. In this example, the stopping condition is not met in response to the capture characteristic of the relative speed being below the maximum threshold 1410 for 10 consecutive images. Therefore, the images no. 4 to no. 12 and no. 48 to no. 56 may still be buffered. However, in this example, the electronic device 500 may determine, during the post-processing analysis, that the capture characteristic (related to the relative speed being below the maximum speed threshold 1410) is not met for eighteen images of the stream of images. In this example, the ratio between a number of buffered images for which the capture characteristic is not met, and a number of buffered images for which the capture characteristic is met may nonetheless be above the ratio threshold (e.g. 0.15, which corresponds to 80*1.5=12 in the illustrative example of FIG. 14). Therefore, the electronic device 500 may discard the buffered images in the example of FIG. 14.

In some implementations, the capture characteristics are partitioned into priority capture characteristics and non-priority capture characteristics. Therefore, the capture characteristics that will be assessed by the electronic device 50 may be either flagged as priority or non-priority. In circumstances where the assessed capture characteristic includes at least one priority capture characteristic and at least one non-priority capture characteristics, the electronic device 50 first determines whether the priority capture characteristics are met. The electronic device 50 determines whether the non-priority capture characteristics are met only once determination has been done that the priority capture characteristics are met. This sequence of assessment may help in reducing computer complexity, by reducing a number of calculations related to capture characteristics for each image. In some implementations, all the assessed capture characteristics are considered met in response to the priority capture characteristics are met. Therefore, an image may be buffered in response to only the priority capture characteristic being met and the non-priority capture characteristics being not met.

FIGS. 6A and 6B illustrate an example of executions of the pipeline 400 on the stream 500 according to some other non-limiting implementations of the present technology. The illustrative example of FIGS. 6A and 6B differs from the one of FIG. in that the capture characteristic CC3 is a priority capture characteristic (indicated by a star symbol on FIGS. 6A and 6B) and the capture characteristic CC1 and CC2 are non-priority capture characteristics.

In addition, all the assessed capture characteristics are considered met in response to the priority capture characteristics being met in the implementation of FIG. 6A. Therefore, the electronic device 50 determines that all the capture characteristics CC1, CC2 and CC3 are met on the image 5022. The image 5022 is thus buffered and added to the buffered sequence 500′.

The same applies to the images 5026 and 5027 where the electronic device 50 causes the buffering of the images 5026 and 5027 in response to determining that the priority capture characteristic CC3 is met for these images.

The same also applies to the images 50210 and 50211 where the electronic device 50 causes the buffering of the images 50210 and 50211 in response to determining that the priority capture characteristic CC3 is met for these images. Since all the capture characteristics are considered met by the electronic device 50 for image 50211 given that the priority capture characteristic CC3 is met, the images 50212 and 50213 are also buffered. Indeed, the images 50212 and 50213 are buffered given that, upon buffering a first portion of the stream of images (here images 5028 to 50211) and determining that the capture characteristic is not met for a given image (here image 50212) consecutive to the first portion in the stream of images, the electronic device 100 causes a buffering of a pre-determined number of images consecutive to the first portion of the stream of images including the given image. In this example, the pre-determined number of images is two. Therefore, image 502₁₃ is also buffered.

In alternative implementations, a given image is not buffered in response to the priority capture characteristic being not met. Therefore, in these implementations, images 502₁, 502₅, 502₉ and 502₁₂ would not be buffered.

In the same or alternative implementations, the buffering of the images is stopped in response a capture characteristic being not met for a pre-determined number (e.g. ten) successive images of the stream 500. With reference to FIG. 6B, the capture characteristic CC1 is not met for ten successive images 502₄ to 502₁₃. In response, the buffering of the images is stopped. An indication of the unmet capture characteristic (in this example CC1) may be returned to the user.

It should be noted that the buffered sequence 500′ forms a dataset fitted for further processing. In other words, the buffered images have been buffered by assessing whether capture characteristics were met, therefore it can be said that the capture of the object-of-interest on these images is optimized based on said capture characteristics. The capture characteristics may thus be selected such that the images that are buffered are optimized for a further processing operation compared to the images that were not buffered.

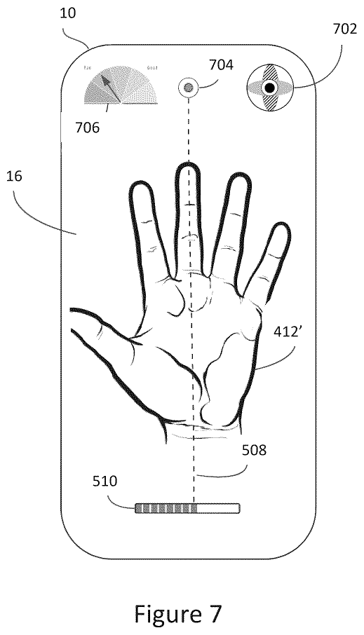

FIG. 7 depicts a representation 412′ of the object-of-interest 412 on the display 16 of the electronic device 50. The representation 412′ is based on images captured by the imaging system 18. In the implementation of FIG. 7, the electronic device 50 determines three capture characteristics of the object-of-interest: a relative position of the object-of-interest with respect to the imaging system 18, a quality of the background of the object-of-interest and a brightness of the object-of-interest.

In this implementation, in addition to the representation 412′, the electronic device 50 causes the display of a first visual indicator 702, a second visual indicator 704, and a third visual indicator 706, respectively indicative of three aforementioned capture characteristics of the object-of-interest. The first visual indicator 702, second visual indicator 704, and third visual indicator 706 are overlayed on the representation 412′.

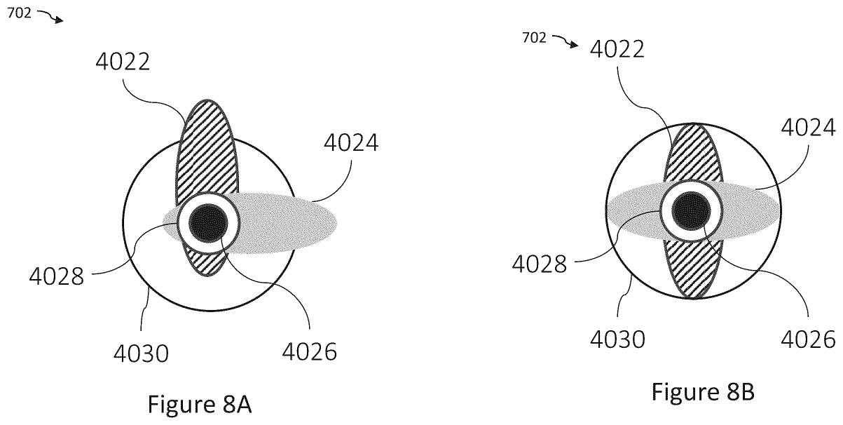

More specifically, with additional reference to FIGS. 8A to 8E, the first visual indicator 702 is indicative of relative position of the object-of-interest with respect to the imaging system 18. In this implementation, the relative position are determined in a orthonormal coordinate system using sets of (x,y,z) coordinates. Other types of coordinate systems may be used in alternative implementations. Therefore, a first capture characteristic of the object-of-interest 412 determined by the electronic device 10 is the relative position to the imaging system 18.

In this implementation, the electronic device 50 may set an origin of the coordinate system at the imaging system 18, a direction substantially orthogonal to a surface of the imaging system 18 (e.g. a lens thereof) being the z-axis of the coordinate system. It should be understood that, given the imaging system 18 is implemented in the electronic device 50, the z-axis is substantially orthogonal to the front side 310 and/or rear side 320 of the electronic device 50. The y-axis and x-axis thus extend orthogonally to the z-axis and substantially parallel to the front side 310 and/or rear side 320 of the electronic device 50. Therefore, a distance between the imaging system 18 and the object-of-interest 412 extends substantially along the z-axis.

Referring to FIGS. 8A and 8B, an x-position indicator 4024 is indicative a relative position between the imaging system 18 and the object-of-interest 412 along the x-axis. A y-position indicator 4022 is indicative a relative position between the imaging system 18 and the object-of-interest 412 along the y-axis.

In this implementation, an optimal position along the x axis is reached when the x-position indicator 4024 is contained in a position ring indicator 4030. Similarly, an optimal position along the y axis is reached when the y-position indicator 4022 is contained in the position ring indicator 4030. FIG. 8A depicts the visual indicator 702 when the optimal relative positions of the object-of-interest are not reached along the x and y axes, and FIG. 8B depicts the visual indicator 702 when the optimal relative positions of the object-of-interest are reached along the x and y axes.

The visual indicator 702 also includes a z-position indicator 4026 is indicative of a relative distance between the imaging system 18 and the object-of-interest 412 along the z-axis. In this implementation, an optimal position along the z axis is reached when the z-position indicator 4026 matches a position ring indicator 4028. FIGS. 8C and 8D depict the visual indicator 702 when the optimal relative distance of the object-of-interest is not reached along the z-axis, respectively indicative of a too short and a too long relative distance along the z-axis. FIG. 8E depicts the visual indicator 702 when the optimal relative position of the object-of-interest is reached along the z axis.

In use, the x-position indicator 4024, the y-position indicator 4022 and the z-position indicator 4026 are adjusted based on a current position of the imaging system 18 relatively to the object-of-interest, in a near-to-real time manner. More specifically, in this implementation, the x-position indicator 4024 and the y-position indicator 4022 slides along rays of the position ring indicator 4030, and the z-position indicator 4026 grows and shrinks at a center of the position ring indicator 4028. The user may adjust a position of the object-of-interest 412 and/or a position of the imaging sensing device 18 based on indication provided by the visual indicator 702 such that an optimal relative position between the object-of-interest 412 and the imaging sensing device 18 is reached. More specifically, the capture characteristic relating to the relative position is within a range of target values in response to the x-position indicator 4024 is within the position ring indicator 4030, the y-position indicator 4022 is within the position ring indicator 4030 and the z-position indicator 4026 matches the position ring indicator 4028.

The relative position may be determined based on a position of the object-of-interest 412 in the captured images and/or a depth map associated with the object-of-interest 412. In some implementations, the capture characteristic relating to the relative position is determined by employing a trained machine learning algorithm (MLA), said MLA being trained to determine the relative position based on input including the information provided by the imaging system 18.

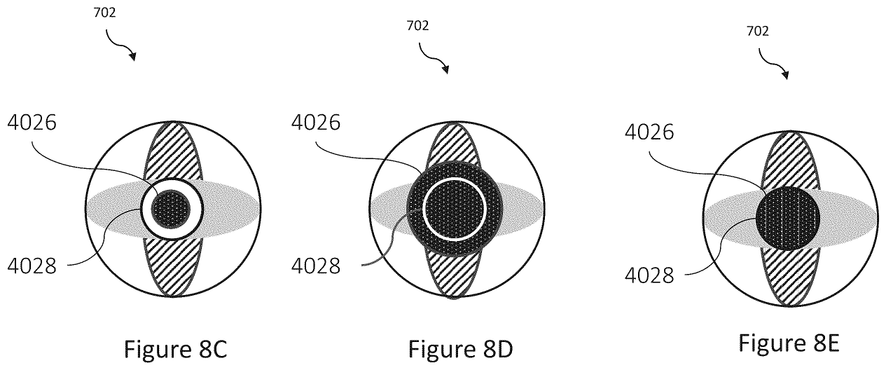

FIGS. 9A to 9C depicts a second visual indicator 704 indicative of a quality of a background of the object-of-interest. In this implementation, the visual indicator 704 includes a quality indicator 4042 centered in a quality boundary ring 4046 defining an acceptable background quality region 4044 and an unacceptable background quality region 4048.

In use, the electronic device 50 determines a quality score of the background of the object-of-interest 412. For example, the electronic device 10 may determine a color distribution of elements of the background and may further determine the quality score based on a standard deviation of the color distribution. The electronic device 10 may also determine a color distribution of elements of the object-of-interest 412. In addition or alternatively, the electronic device 10 may determine an average noise level of the background and further determine the quality score thereon. In this implementation, a size of the quality indicator 4042 is proportional to the quality score. More specifically, in this example, a diameter of the circular quality indicator 4042 is proportional to the quality score.

FIG. 9A depicts background quality indicator 4042 contained within unacceptable background quality region 4048. This example may indicate to a user that the background of object-of-interest 412 is not optimal for the capture of the geometric data. In response, the user may thus adjust the background of the object-of-interest 412 until the quality indicator 4042 matches the background quality boundary ring 4046, or is contained within the acceptable background quality region 4044.

For example and without limitation, the user may adjust a position of the object-of-interest 412 relatively to a background wall, place the object-of-interest 412 in front of a uniform background texture such as a white wall or white ceiling, adjust a color of the scene, provide uniform lighting of the background, increase the amount of light impacting a background surface, and/or remove reflective surfaces from the background.

FIG. 9B depicts background quality indicator 4042 contained within the acceptable background quality region 4044. Referring to FIG. 9C, this illustrative example depicts the background quality indicator 4042 matching the background quality boundary ring 4046. This example may indicate to a user that the background of the object-of-interest 412 has a relative quality score high enough such that the electronic device 10 may start capturing the geometric data of the object-of-interest 412. More specifically, the characteristic of the object-of-interest relating to the background is within a range of corresponding target values in response to the background quality indicator 4042 contained within the acceptable background quality region 4044.

In some implementations, the characteristic relating to the background quality is determined by employing a trained machine learning algorithm (MLA), said MLA being trained to determine the background quality score based on input including the information provided by the imaging system 18.

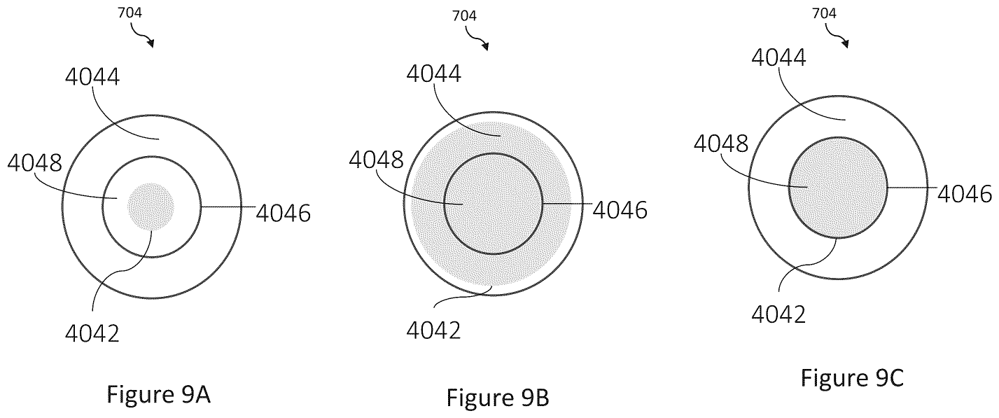

An illustrative example of a third visual indicator 706 is depicted in FIG. 10. In this implementation, the third visual indicator 706 is indicative of a brightness of the object-of-interest 412. More specifically, the visual indicator 706 includes a light condition indicator 4062, and a plurality of light characteristic regions. In this implementation, the visual indicator 706 includes five light characteristic regions 4064, 4066, 4068, 4070 and 4072.

In use, the electronic device 10 receives information about light conditions relative to the object-of-interest 412, and optionally the background thereof, from the imaging system 18 and adjust the light condition indicator 4062 based thereon. Said information may include lux, lumens, wavelength and/or temperature.

Information received from the imaging system 18 may be processed and compared to pre-determined threshold to determine a position of the light condition indicator 4062 in the light characteristic regions 4064, 4066, 4068, 4070 and 4072. For example, pre-determined light condition criteria may be assessed by comparing information about an illuminance to an illuminance threshold, comparing information about a color to one or more color thresholds, comparing information about a luminance to a luminance threshold, etc. In this implementation, the more light condition criteria are fulfilled, the closer to the light characteristic region 4072 the light condition indicator 4062 is displayed.

In one implementation, five criteria are defined, each criterion being associated with a given threshold. In this example, the light condition indicator 4062 is displayed in the light characteristic region 4064 in response to only one or no criterion being fulfilled. The light condition indicator 4062 is displayed in the light characteristic region 4066 in response to two criteria being fulfilled. The light condition indicator 4062 is displayed in the light characteristic region 4068 in response to three criteria being fulfilled. The light condition indicator 4062 is displayed in the light characteristic region 4070 in response to four criteria being fulfilled. The light condition indicator 4062 is displayed in the light characteristic region 4072 in response to the five criteria being fulfilled. A matching between the number of criteria and the number of light characteristic regions is not limitative.

In this implementation, the light conditions are considered optimal by the electronic device 10 for the capture of the geometric data in response to the light condition indicator 4062 being either in the light characteristic region 4072 or light characteristic region 4070. More specifically, the characteristic of the object-of-interest relating to the light conditions is within a range of corresponding target values in response to the light condition indicator 4062 being either in the light characteristic region 4072 or light characteristic region 4070.

In some implementations, the characteristic relating to the light conditions is determined by employing a trained machine learning algorithm (MLA), said MLA being trained to determine the light conditions based on input including the information provided by the imaging system 18.

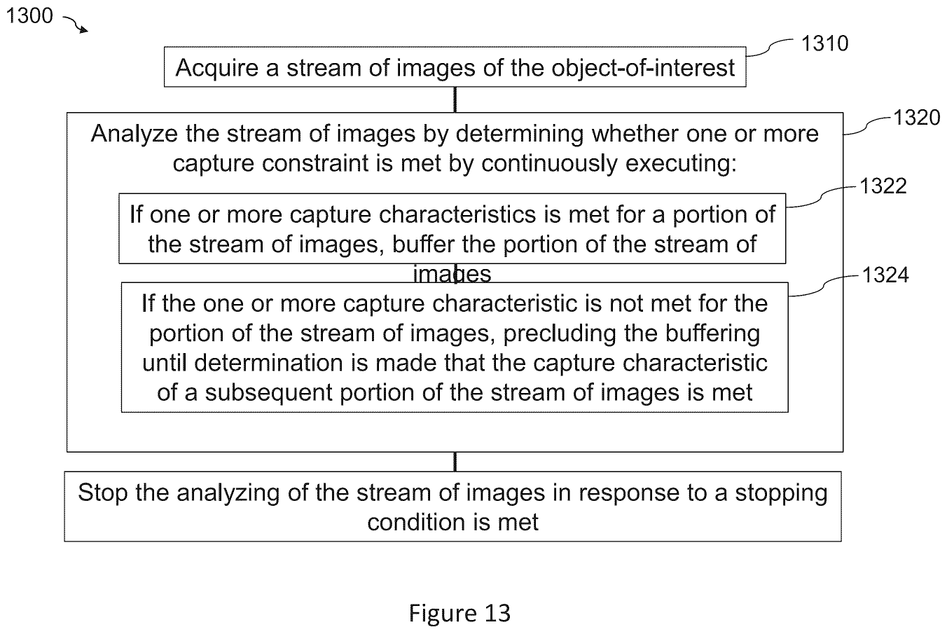

FIG. 13 is a flow diagram of a method 1300 for generating a dataset associated with an object-of-interest, such as the object-of-interest 412, according to some implementations of the present technology. In one or more aspects, the method 1300 or one or more steps thereof may be performed by a processor or a computer system, such as the computer system 100. The method 1300 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 1300 starts with acquiring, at operation 1310, a stream of images of the object-of-interest by an imaging system. The imaging system may be for example and without limitation the imaging system 18. The stream of images may be a live stream of images in some implementations. For example and without limitation, the object-of-interest may be a portion of a human body such as a wrist.

The method 1300 continues with analyzing, at operation 1320, the stream of images by determining whether one or more capture constraint is met. The analysis is performed by continuously executing the following sub-operations.

At sub-operation 1322, the method 1300 includes buffering a portion of the stream of images if one or more capture characteristics is met for the portion of the stream of images. The portion of the stream of images may be a single image of the stream of images in some implementations. In use, the buffering of the portion of the stream of images defines the dataset fitted for further processing. The dataset may be, for example and without limitation, formed by raw images of the buffered portion of the stream of images.

In some implementations, for a given capture characteristic, determining whether the given capture characteristic is met includes determining a characteristic value of the given capture characteristic and comparing the characteristic value with a pre-determined criterion. The given capture characteristic is met in response to the pre-determined criterion being fulfilled. For example, the pre-determined criterion for the capture characteristic related to the brightness of an image may be fulfilled in response to the brightness being below a first threshold and above a second threshold. As another example, the pre-determined criterion for the capture characteristic related to the Bluetooth communication may be fulfilled in response to the Bluetooth communication being enabled a first threshold and not fulfilled otherwise.

It can be said that some of the capture characteristics relate to features of the object-of-interest and/or the imaging system. A given capture characteristic is selected in a group of capture characteristics that includes the aforementioned examples of capture characteristics such as, for example and without limitation, a brightness of the object-of-interest and a background thereof, a relative position of the object-of-interest with respect to the imaging system, a color temperature of the object-of-interest and the background thereof, a relative speed of the object-of-interest with respect to the imaging system, a quality of a background of the object-of-interest, and presence of one or more geometric features of the object-of-interest.

In some implementations, the capture characteristics are partitioned into priority and non-priority capture characteristics. In these implementations, the one or more capture characteristic may include a first priority capture characteristic and a second non-priority capture characteristic. The analyzing of the stream of images thus includes determining whether the first priority capture characteristic is met. In response to the first priority capture characteristic being met, the method 1300 further includes determining whether the second non-priority capture characteristic is met. In response to the first priority capture characteristic being not met, the method 1300 further includes precluding the buffering of the portion of the stream of images. In some implementations, the method 1300 further includes, in response to the first capture characteristic being met, buffering of the portion of the stream of images.

In the same or other implementations, determining whether a given capture characteristic is met comprises employing a machine learning algorithm (MLA).

In the same or other implementations, the method 1300 includes, upon buffering a first portion of the stream of images and determining that the capture characteristic is not met for a given image consecutive to the first portion in the stream of images, buffering a pre-determined number of images consecutive to the first portion of the stream of images including the given image.

For example, the portion of the stream of images may be buffered and stored on a memory communicably connected to the imaging system. The memory may be hosted in an electronic device embedding the imaging system, such as the electronic device 50, or on a server communicably connected to the memory such that the dataset fitted for further processing is transmitted to the server. In this example, the memory is a server remotely connected to the imaging system.

At sub-operation 1324, the method 1300 includes precluding the buffering if the one or more capture characteristic is not met for the portion of the stream of images, until determination is made that the capture characteristic of a subsequent portion of the stream of images is met.

In some implementations, the method 1300 may include providing instructions to a user of the imaging system, an execution of the instructions causing the one or more capture characteristic to be met.

The method 1300 continues with stopping, at operation 1330, the analyzing of the stream of images in response to a stopping condition is met. For example and without limitations, the stopping condition may be met in response to a number of buffered images reaches a pre-determined threshold, and/or the one or more capture characteristics of the buffered portion of the stream of images meets a pre-determined criterion.

In some implementations, the method further includes executing a post-processing analysis of the buffered portion of the stream of images. The post-processing analysis includes discarding, in response to a number of images of the buffered portion of the stream of images for which the capture characteristic is not met is above a predetermined threshold, the buffered portion of the stream of images.

In these implementations, the method 1300 may also include causing, in response to a number of images of the buffered portion of the stream of images for which the capture characteristic is not met is above a predetermined threshold, the acquisition and analysis of another stream of images.

In the same or other implementation, the method 1300 may further include providing, to a user of the imaging system, an indicator indicative of a current value of the capture characteristic in a near-to-real time manner on a user device. For example, providing the indicator may include overlaying the indicator on a representation of the object-of-interest on the user device, causing the user device to vibrate (e.g. also referred to as “haptics”), vibrations being modulated based on a number of buffered images, and/or causing the user device to emit sound effects, the sound effects being modulated based on a number of buffered images.

The method 1300 may further include determining target features of the object-of-interest based on the dataset fitted for further processing.

While the above-described implementations have been described and shown with reference to particular steps performed in a particular order, it will be understood that these steps may be combined, sub-divided, or re-ordered without departing from the teachings of the present technology. The steps may be executed in parallel or in series. Accordingly, the order and grouping of the steps is not a limitation of the present technology.

It will be appreciated that at least some of the operations of the method 1300 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which includes storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

It will be understood that the features and examples above are not meant to limit the scope of the present disclosure to a single implementation, as other implementations are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed to an uncommon or special meaning unless explicitly set forth as such. Further, the present disclosure encompasses present and future known equivalents to the known components referred to herein by way of illustration.

The present description of the specific implementations so fully reveals the general nature of the disclosure that others can, by applying knowledge within the skill of the relevant art(s) (including the contents of any documents cited and incorporated by reference herein), readily modify and/or adapt for various applications such specific implementations, without undue experimentation and without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various implementations of the present disclosure have been described above, it should be understood that they have been presented by way of example, and not limitation. It would be apparent to one skilled in the relevant art(s) that various changes in form and detail could be made therein without departing from the spirit and scope of the disclosure. Thus, the present disclosure should not be limited by any of the above-described implementations but should be defined only in accordance with the following claims and their equivalents.

1. A computer-implemented method for generating a dataset associated with an object-of-interest, the method comprising:
acquiring, by an imaging system, a stream of images of the object-of-interest;
analyzing the stream of images by determining whether one or more capture constraint is met, the analysis being performed by continuously executing:
if one or more capture characteristics is met for a portion of the stream of images, buffering the portion of the stream of images, the buffering of the portion of the stream of images defining the dataset, the dataset being fitted for further processing;
if the one or more capture characteristic is not met for the portion of the stream of images, precluding the buffering until determination is made that the capture characteristic of a subsequent portion of the stream of images is met; and
stopping the analyzing of the stream of images in response to a stopping condition being met.

2. The method of claim 1, wherein, for a given capture characteristic, determining whether the given capture characteristic is met comprises:
determining a characteristic value of the given capture characteristic; and
comparing the characteristic value with a pre-determined criterion, the given capture characteristic being met in response to the pre-determined criterion being fulfilled.

3. The method of claim 1, wherein a given capture characteristic relates to features of the object-of-interest and/or the imaging system.

4. The method of claim 1, wherein a given capture characteristic is selected in a group of capture characteristics comprising: a brightness of the object-of-interest and a background thereof, a relative position of the object-of-interest with respect to the imaging system, a color temperature of the object-of-interest and the background thereof, a relative speed of the imaging system with respect to the object-of-interest, a quality of a background of the object-of-interest, and presence of one or more geometric features of the object-of-interest.

5. The method of claim 1, wherein the one or more capture characteristic comprises a first capture characteristic and a second capture characteristic, and analyzing the stream of images comprises:
determining whether the first capture characteristic is met, the first capture characteristic being selected in a group of priority capture characteristics;
in response to the first capture characteristic being met, determining whether the second capture characteristic is met, the second capture characteristic being selected in a group of non-priority capture characteristics; and
in response to the first capture characteristic being not met, precluding the buffering of the portion of the stream of images.

6. The method of claim 5, further comprising, in response to the first capture characteristic being met, buffering of the portion of the stream of images.

7. The method of claim 1, wherein determining whether a given capture characteristic is met comprises employing a machine learning algorithm (MLA).

8. The method of claim 1, wherein the stopping condition is met in response to:
determining that a number of consecutive images of the stream of images for which the capture characteristic is not met is above a predetermined threshold.

9. The method of claim 1, wherein the stopping condition is met in response to:
a number of buffered images reaches a pre-determined threshold, and/or
the one or more capture characteristics of the buffered portion of the stream of images meets a pre-determined criterion.

10. The method of claim 9, further comprising:
executing a post-processing analysis of the buffered portion of the stream of images, the post-processing analysis comprising discarding, in response to a number of images of the buffered portion of the stream of images for which the capture characteristic is not met is above a predetermined threshold, the buffered portion of the stream of images.

11. The method of claim 10, further comprising, in response to a number of images of the buffered portion of the stream of images for which the capture characteristic is not met is above a predetermined threshold:
causing the acquisition and analysis of another stream of images.

12. The method of claim 1, further comprising, upon buffering a first portion of the stream of images and determining that the capture characteristic is not met for a given image consecutive to the first portion in the stream of images:
buffering a pre-determined number of images consecutive to the first portion of the stream of images including the given image.

13. The method of claim 1, further comprising providing, to a user of the imaging system, an indicator indicative of a current value of the capture characteristic in a near-to-real time manner on a user device.

14. The method of claim 13, wherein providing the indicator comprises:
overlaying the indicator on a representation of the object-of-interest on the user device;
causing the user device to vibrate, vibrations being modulated based on a number of buffered images; and/or
causing the user device to emit sound effects, the sound effects being modulated based on a number of buffered images.

15. The method of claim 1, wherein buffering the portion of the stream of images comprises storing the portion of the stream of images on a memory communicably connected to the imaging system.

16. The method of claim 15, wherein the memory is hosted in an electronic device embedding the imaging system.

17. The method of claim 16, further comprising transmitting the dataset fitted for further processing to a server communicably connected to the memory.

18. The method of claim 15, wherein the memory is a server remotely connected to the imaging system.

19. The method of claim 1, wherein the dataset is formed by raw images of the buffered portion of the stream of images.

20. (canceled)

21. (canceled)

22. (canceled)

23. (canceled)

24. (canceled)

25. A system for generating a dataset associated with an object-of-interest, the system comprising a controller and a memory storing a plurality of executable instructions which, when executed by the controller, cause the system to perform the method of claim 1.

26. (canceled)
